(19) United States
(12) Patent Application Publication
(10) Pub. No.: US 2009/0125722 A1
(43) Pub. Date: May 14, 2009

(54) CROSS-PLATFORM DIGITAL RIGHTS MANAGEMENT PROVIDING MULTI-LEVEL SECURITY INFORMATION FLOW TRACKING

(75) Inventors: Ahmed A. Gomaa, Glen Ridge, NJ (US); Deepen Sinha, Chatham, NJ (US)

Correspondence Address: DARBY & DARBY P.C., P.O. BOX 770, Church Street Station, New York, NY, 10008-0770, US

(73) Assignee: iMedia Streams, LLC, Newark, NJ (US)

(21) Appl. No.: 12/209,893

(22) Filed: Sep. 12, 2008

Related U.S. Application Data
(60) Provisional application No. 60/993,693, filed on Sep. 12, 2007.

(51) Int. Cl. G06F 21/00; H04L 9/00

(52) U.S. Cl. 713/176; 726/27; 726/1

(57) ABSTRACT

A method and system for generating and controlling access to copy-protected digital media files. Digital media content is obtained and encoded in electronic file using a media codec. The encoded media content is encrypted in the electronic file and a multi-format renderer configured to render the encoded, encrypted electronic file is embedded in the electronic file. When the digital file is accessed, the multi-format renderer generates an invocation code identifying an operation-type in response to a requested operation. A transaction ID storing a user-access policy and associated with the electronic file is retrieved and compared to the invocation code. Based on a result of the comparison of the invocation code and the user-access policy, the multi-format renderer selectively allows the invocation code.

### CROSS-PLATFORM DIGITAL RIGHTS MANAGEMENT PROVIDING MULTI-LEVEL SECURITY INFORMATION FLOW TRACKING

This application claims priority under 35 U.S.C. § 119(e) to U.S. Provisional Patent Application Ser. No. 60/993,693, filed Sep. 12, 2007, which is hereby incorporated by reference as though set forth in its entirety herein.

### FIELD OF THE INVENTION

The present invention relates to the creation and usage-tracking of media content, and more particularly to a method and system for cross-platform digital rights management of media content that provides multiple levels of security and information flow tracking.

### BACKGROUND OF THE INVENTION

With the advent of the Internet, the distribution of media (e.g., music, movies, games, software, and books) in digital format has attained a significant role in e-commerce. Its significance is only likely to increase as network access becomes cheaper and nearly ubiquitous and as consumers become more accustomed to purchasing content in an electronic form, as opposed to physical media.

The sale and distribution of media content using a digital medium provides simple and flexible production, consumption, and transmission of such content. However, it also reduces the efforts needed for unauthorized reproduction, transmission, and consumption of this data. Thus, digital media content is more easily copied, distributed, or used in a manner not allowed by law or license agreement.

Lawmakers recognized the growing need to protect digital media and enacted the US Digital Millennium Copyright Act (DMCA) crafted to protect property rights in the digital world while facilitating the robust development of electronic commerce, communications, research and development, and education in the digital age.

One approach to curbing the proliferation of illegal activity surrounding digital media content is to incorporate a form of Digital Rights Management (DRM) into the digital content. DRM can be used to detect and verify ownership of data and to control access to the data in accordance with a policy determined by the content creator or distributor.

A further approach frequently incorporated in a DRM system is to embed a digital watermark in the digital media file. A digital watermark is information that is generated and interspersed in the data of the digital media file but cannot be perceived by the audience of the digital media file. For example, to a listener, a digital audio file that contains a watermark would sound identical to the digital audio file without the watermark. However, an examination of the data (e.g., by media player software) can detect (i.e., extract) the watermark to determine if the file has been modified in someway. Possible modifications that could alter the watermark include lossy compression of the data, cropping an image or video or attempted removal of the watermark. Watermarking can also be used to fingerprint a file, such that different recipients receive differently watermarked content. Thus, by examining the watermark, the proper owner of a file can be determined and any tampering with the file can be detected.

Current commercial DRM solutions focus on watermarking digital media content to indicate ownership of a specific copy of the content and ways to track and prevent unauthorized reproductions and distributions. One such solution is WINDOWS MEDIA RIGHTS MANAGER (i.e., WINDOWS MEDIA DRM 10). However, this solution is limited to a WINDOWS environment and is not compatible or accessible on other computing platforms. Furthermore, it provides only a single layer of security, which if defeated can expose all content distributed with the system.

What is needed in the art is a platform-independent DRM system for managing, protecting, distributing, and tracking the usage of digital media content and providing robust multi-level security to prevent the subversion of the protection system.

### SUMMARY OF THE INVENTION

In accordance with one aspect of the present invention, a method for generating and controlling access to copy-protected media files is provided. Digital media content is obtained and encoded in an electronic file using a media codec. The encoded media content is encrypted and stored in the electronic file. A multi-format renderer configured to render the encoded, encrypted electronic file is also embedded in the electronic file.

In a further aspect of the present invention, the multi-format renderer can control access to the digital media content based on a user-access policy. In response to a requested operation on the electronic file, the multi-format renderer generates an invocation code that identifies an operation-type of the requested operation. A transaction ID storing a user-access policy and associated with the electronic file is retrieved and compared to the invocation code. Based on a result of the comparison of the invocation code and the user-access policy, the multi-format renderer selectively responds to the invocation code and the request operation.

In yet a further aspect of the present invention, a system for generating and controlling access to copy-protected media files is provided. The system includes a server having a processor and a computer readable medium encoding a server software program. The server software program is configured to encode, encrypt, and optionally compress the media content, store the resulting data in the digital media file, embed a transaction ID that stores a user-access policy in the digital media file, and embed a multi-format renderer in the digital media file. The multi-format renderer is configured to render the compressed encrypted electronic file, and is further configured to generate an invocation code in response to a requested operation on the electronic file, retrieve the transaction ID associated with the electronic file, compare the invocation code to the user-access policy, and selectively respond to the requested operation based on a result of the comparison of the invocation code to the user-access policy.

These and other aspects, features and advantages will be apparent from the following description of certain embodiments and the accompanying drawing figures.

### BRIEF DESCRIPTION OF THE FIGURES

FIG. 1 is a flow diagram of a method for generating an electronic file containing media content encoded with a digital rights management scheme in accordance with an embodiment of the present invention;

FIG. 2 is a flow diagram of a method for processing and tracking access to an electronic media file generated in accordance with an embodiment of the present invention;

FIG. 3 is an exemplary layout of an electronic media file generated in accordance with an embodiment of the present invention; and

FIG. 4 is a flow diagram of a method for accessing an electronic media file generated in accordance with an embodiment of the present invention.

### DETAILED DESCRIPTION OF CERTAIN PREFERRED EMBODIMENTS

By way of overview and introduction, the present invention provides a method and system for generating digital media files encoded with a platform-independent DRM scheme, rendering the encoded files (e.g., playing the encoded music or video file), and tracking the usage of the file. For example, when a consumer purchases a digitally encoded music file, in addition to the electronic file that is acquired, the consumer may be obtaining a license to play the music a certain number of times and create a number of copies of the music. For example, the consumer may purchase a more limited license that allows the file to be played up to three times in a 24-hour period, make no copies of the file, and prevents the consumer from reviewing (i.e., rewinding) the file. What the purchaser is allowed to do with or to the file is referred to as the user-access policy. In accordance with the present invention, the user-access policy of the license is stored in a Transaction ID that is associated with the consumer or file.

When the file is accessed, such as during playback, the renderer (e.g., player software) is executed on the consumer's computer. The renderer is preferably a multi-platform software program that is embedded in the digital media file and enables the consumer to access the file in various computing environments (e.g., MICROSOFT WINDOWS, APPLE OSX, and LINUX). Once the renderer is loaded, the user-access policy associated with the file is compared to the requested access and the appropriate response determined (e.g., whether to play the music file). The renderer can also perform additional security checks, including watermark extraction and decryption, to determine whether access should be granted to the contents of the file.

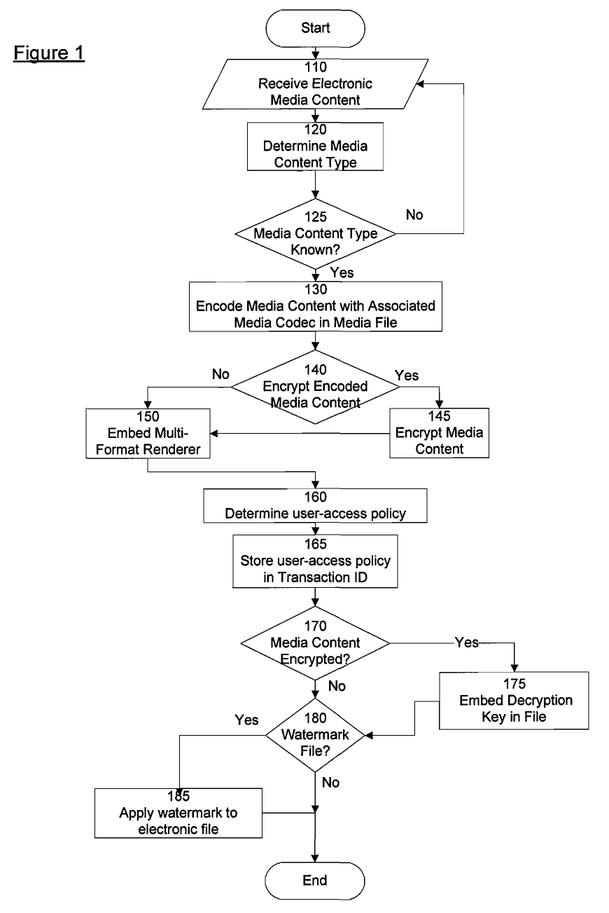

With reference now to the figures, FIG. 1 is a flow diagram of a method for generating an electronic file containing media content encoded with a digital rights management scheme in accordance with an embodiment of the present invention (i.e., a generation process 100). The generation process 100 can be performed by a single computer having a processor, memory, and computer readable medium encoded with a software program for generating electronic media files in accordance with the invention. However, it is well known in the art that the creation of the electronic media file can also be performed in a distributed system having multiple computers each configured to perform one or more steps of the electronic media file generation process 100. The computers of the distributed system can be provided access to a shared storage medium (e.g., a database or a network storage device), such that each computer can access the contents of the electronic media as needed during the generation process 100. Alternatively, as each computer processes the electronic file, the results can be transmitted to the computer performing the next step of the generation process 100. For ease of description, the generation process 100 is described below as being performed by a single server computer.

At step 110 the server computer receives the electronic media content. The media content can include an electronic file, database entry, network stream, or other type of digital communication. Alternatively, analog content can be received by the server computer through an appropriately configured acquisition device such as a scanner, video capture card, or microphone/line-input and converted into digital content.

The media type of the electronic content is determined at step 120. This determination can be performed manually by receiving user input or automatically by examining the data of the electronic content and comparing it to known data formats. Alternatively, the server computer can be configured to process a single type of media so as to bypass step 120. If the media content type is unknown at step 125, the computer can record data concerning the unknown content and proceed to step 110 to receive new electronic media content.

If the type of the media content is known, an associated media codec is selected to encode the media content at step 130. Media content in its raw form can require significant storage space and consequently significant bandwidth for network transfer. Therefore, most electronic media content is encoded using a codec that compresses the data. Audio, video, speech, and, image data compression techniques frequently rely on the removal of redundancies and the elimination of perceptual irrelevancies (i.e., aspects of the media content that, if removed, are not perceived as missing by the consumer). Examples of audio compression formats include the MP3 format, AAC format, and other standards-based and proprietary formats. Similarly, video compression schemes, such as MPEG-2, MPEG-4, and DivX, are frequently used. The media codec used at step 130 can be configurable, for example by the vendor, owner, or distributor of the media content.

It should be noted that, in addition to reducing the file size of the media content, proprietary compression schemes can also provide a level of encryption. The large size of codebooks (i.e., lookup table for coding and decoding) used in modern perceptual compression schemes makes it very difficult to render the data without a detailed knowledge of the format of the data. Therefore, data encoded with such a scheme can only be rendered practically using a renderer supplied by or licensed by the developer of the proprietary compression scheme. Thus, encoding the media content with a proprietary codec at step 130 can provide a layer of security to the data.

Additional encryption of the media content can further secure the digital content. At step 140, the server computer can determine whether the media content should be encrypted. This determination can be made based on various criteria including user input as well as content meta-data such as the producer, owner, distributor, creator, and license purchased, and codec used. For example, the server computer can be configured to examine a rule base at step 140 that may include a rule requiring content owned by a specific party and encoded using a certain codec to be encrypted at step 145.

Various known encryption techniques can be utilized at step 145, such as DES, AES, RC4, RSA, or others. Preferably, the media content is encrypted using asymmetric cryptography (i.e., public/private key cryptography). The public key can be embedded in the in the renderer and the media content encrypted using the private key. Thus, the media content is signed and can be verified by the embedded renderer. If the media content is altered, the renderer will fail to decrypt the content and recognize the content as having been impermissibly modified. The keys can change on a per user or a per file basis. Additionally, embedding encryption keys in the renderer, which is embedded in the file (as discussed below), prevents modification of the renderer, as modifications can corrupt the embedded key.

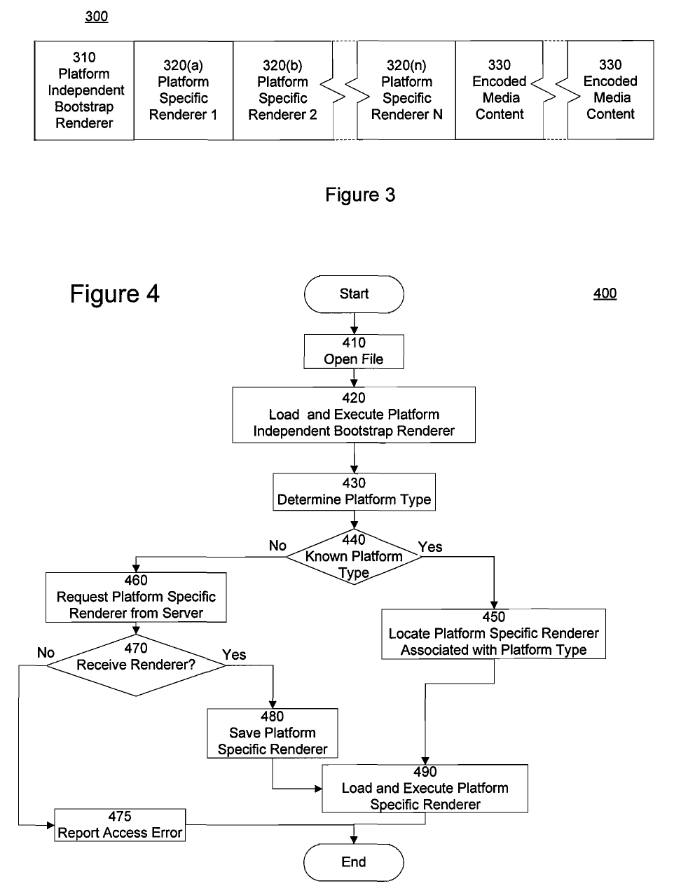

Each digital media file includes the software program required to render the encoded and encrypted media content (i.e., a multi-format renderer). Therefore, at step 150, the multi-format renderer is embedded in the file, preferably at the beginning of the file. The multi-format aspect of the renderer enables the media content to be accessed on a variety of computing platforms and is discussed in more detail below with reference to FIGS. 3 and 4. Thus, each file generated in accordance with the present invention is self-rendering.

At step 160, the user-access policy to be associated with the file is determined. The user-access policy describes the rights of the user to access and use the media file. These rights can include limitations on time and date of access, duration of access, number of accesses, access type, and number of permissible copies. That is, the user-access policy can constrain whether the file can be copied, paused, reviewed (i.e., rewound) or scanned (i.e., fast-forward), when the license expires thus making the content no longer accessible, and other conditions such as security concerns preventing the computer from being attached to a network or external storage device.

The user-access policy is stored in the Transaction ID at step 165 and embedded in the digital media file. The Transaction ID can also store other conditional attributes such as the hard disk ID, serial number, Network ID, network Neighbor ID, CPU serial number, and hardware fingerprint. Preferably, the Transaction ID further includes a key to unlock the encoded file.

The server preferably issues a Transaction ID and embeds the ID in the media file before the media file is provided to the consumer. Alternatively, as discussed below, the server can issue the Transaction ID in response to a renderer when a consumer attempts to access the media file.

At step 170, the computer server can determine whether the media content was encrypted at step 145. If the media content was encrypted, then at step 175 the decryption key is embedded in the file. It should be understood by one of ordinary skill in the art, that the step of embedding the encryption key in the digital media file can be performed at any point after the content has been encrypted.

A further level of security and protection can be provided by watermarking the file. At step 180, the computer server can determine whether the file should be watermarked based on selectable criteria similar to those discussed above with respect to encrypting the media content at step 140 (e.g., based on content owner, codec used, date of purchase, etc. . . . ). Watermarking assists in controlling and monitoring the flow of information (e.g., digital media content) after it has been distributed. For example, if a file is watermarked with a unique fingerprint associated with the owner of that file, copies of the file can be traced back to the original owner. Additionally, if each access of a digital media file is monitored by the renderer and reported to a tracking server along with the fingerprint watermark of the file and the identity of the user/consumer of the file, the distributor or owner can monitor unlicensed access to the file.

At step 185, the watermark is applied to the file. The watermarking technique may, for example, be based on Adaptive Segmentation and Space-Frequency representation (WASSFR) or other secure embedded scheme.

It should be understood by one of ordinary skill in the art that various steps of FIG. 1 can be performed in varying order. That is, the specific order in which the steps of the generation process 100 are illustrated and discussed are not required by the present invention but can be re-ordered in various ways to create a digitally encoded media file in accordance with the present invention.

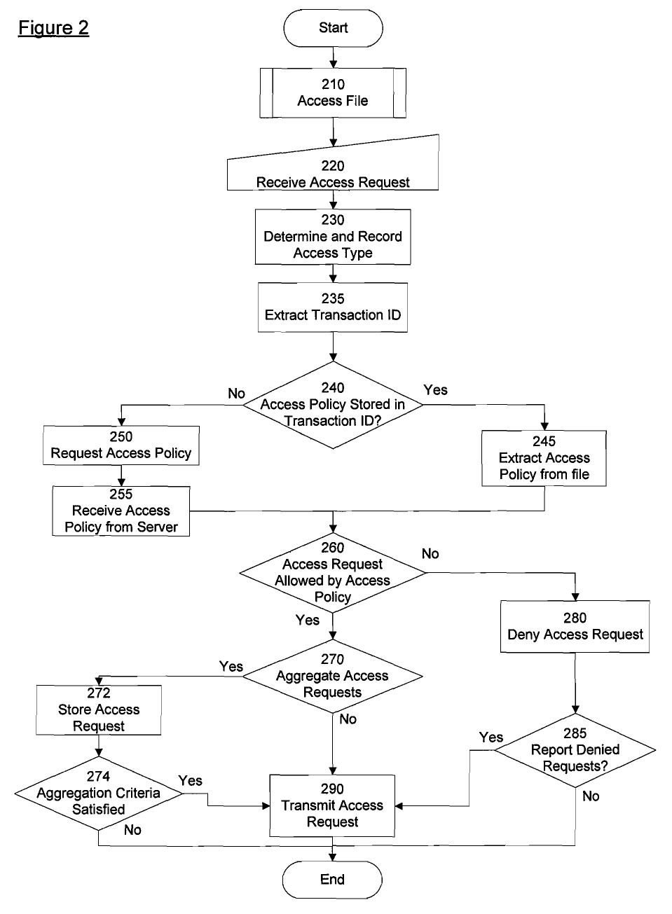

FIG. 2 is a flow diagram of a method for processing and tracking access to an electronic media file (i.e., the access process 200) generated in accordance with an embodiment of the present invention. To process an access request, the multi-format renderer embedded in the digital media file must be loaded at step 210. The process of loading and executing the multi-format renderer is discussed below with respect to FIGS. 3 and 4.

Once the multi-format renderer is loaded at step 210, the access request is received by the renderer at step 220. At step 230, the type of access requested (e.g., play, rewind, pause, etc.) is determined and preferably recorded for auditing or security logging purposes. The renderer preferably generates an invocation code associated with the access request. Optionally, the access request and/or invocation code can include a date and time stamp, identification of the requester (e.g., user ID), identification of the host computer, or other metadata, which can be logged for security audits or used in determining whether to grant the access request.

The transaction ID is extracted from the digital media file at step 235, and at step 240, the transaction ID is examined to determine whether the user-access policy is stored in the transaction ID. If the user-access policy is detected, it is extracted at step 245.

While generation of the digital media file typically includes the determination of the user-access policy (FIG. 1, step 160) and storing the transaction ID in the digital media file (FIG. 1, step 165), the present invention can operate without storing the user-access policy in the digital media file. If the user-access policy is not detected at step 240, the renderer can request the user-access policy from a server over a network. For example, the renderer can determine the information necessary to uniquely identify the consumer and/or digital media file and transmit that information to the server which can lookup the corresponding access policy in a database or generate the access policy based on the information received from the renderer. In order to retrieve or generate the user-access policy, the server may require additional information such as a file creation date, the watermark of the digital media file, the user ID, and the computer ID, which can be communicated to the server by the renderer. After the server retrieves the user-access policy it is transmitted to the renderer and received at step 255. Optionally, the renderer can embed the newly received user-access policy in the digital media file.

It should be noted that the process of requesting the user-access policy from the server and transmitting the necessary information to generate the user-access policy allows the system, and consequently distributors and owners of the media content, to update the user-access policy of the digital media file. For example, in addition to determining if a user-access policy is stored in the transaction ID at step 240, the renderer can perform a license check with the server to determine if the user-access policy is still valid or has been modified since the file was created. In this manner, owners and distributors (i.e., original classifying authorities (OCA)) can control the access policy and modify the license to the digital media file after the data has been distributed to the consumer.

At step 260, the access request is compared to the user-access policy to determine whether the access is permitted. If the user-access policy allows the requested access, the access identified by the invocation code is executed at step 265. Additionally, various meta-data regarding the request can be updated at step 265. For example, the number of times played, the time of first access, the time of the most recent access, or the number of copies made can be updated and stored in the digital media file or other database.

The comparison of the access request to the user-access policy can be performed by the renderer or by a server hosted over a network. Configuring the renderer to perform the comparison ensures that media content is accessible when no network access is present and is generally faster than distributing the comparison task to a networked computer. However, performing the comparison at a networked server eliminates intrusion points that can be attacked by a hacker to bypass the DRM system. For example, a user-access policy that is hosted on a networked server cannot be spoofed or altered because the user will not have access to it.

If the access request is not permitted by the user-access policy, the access is denied at step 280. The system can also be configured to report denied access requests to a server, for example to monitor attempted unauthorized access. At step 285, the renderer can examine the system configuration and determine whether to report the denied access request, and transmit information concerning the denied request at step 290. It should be noted that the reporting of denied access requests can be aggregated as discussed below with respect to reporting allowed access requests (FIG. 2, steps 270-274.)

Once an access request is determined to be allowed, information concerning the request can be reported to a server for monitoring. At step 270, the renderer can determine whether access to the digital media file should be aggregated prior to being reported. Aggregation can conserve network usage and server resources by reducing the number of simultaneous network connections that must be handled by the server. If the system is not configured to aggregate access requests, each allowed access request can be transmitted to the server at step 290. However, if the system is configured to aggregate requests, the request is stored at step 272, and, at step 274, the renderer determines whether an aggregation criteria is satisfied, thereby triggering the transmission of the aggregated requests. Aggregation criteria can include a predetermined size or number of stored requests, a predetermined time since the last transmission of stored requests, and an examination of stored requests for time critical requests (e.g., an access request that exhausts the permissible number of times played). Once the aggregation criteria is satisfied, the stored access requests are transmitted at step 290.

As mentioned above, the processing of any access requests begins by loading the multi-format renderer at step 210. The multi-format renderer is capable of executing in various computing environments thereby enabling the digital media file to be portable across computing platforms. In one embodiment, the multi-format renderer includes a software program coded in a platform independent (i.e., cross-platform) language (e.g., JAVA, Perl, or Python). In this embodiment, as long as the appropriate language interpreter or virtual machine (e.g., Java Virtual Machine) is installed on the host system, the multi-format renderer will execute.

In an alternative embodiment, the multi-format renderer can include a bundle of platform-specific renderers 320(a), 320(b) . . . 320(n) along with a platform-independent bootstrap renderer, preferably appended to either the beginning or end of the file encoding the media content 330. An illustrative diagram of the layout of a digital media file 300 in accordance with this embodiment can be found in FIG. 3. FIG. 4 is a flow diagram of a method for loading the multi-format renderer in accordance with this embodiment of the present invention.

When the digital media file is opened at step 410, the platform-independent bootstrap renderer 310 is loaded and executed at step 420 prior to any platform specific renderer 320(a)-320(n). The platform-independent bootstrap renderer 310 is configured to determine details about the host environment such as the host operating system and host processor type at step 430. Based on that determination, the platform-independent bootstrap renderer 310 determines whether the host environment is known at step 440. That is, the platform-independent bootstrap renderer 310 determines whether one of the platform specific renderers 320(a)-320(n) can be executed in the host environment.

If the host environment is known, the platform-independent bootstrap renderer 310 locates the appropriate platform specific renderer at step 450 and loads and executes the renderer at step 490. For example, platform specific renderer 320(a) may be suitable for a WINDOWS environment, platform specific renderer 320(b) may be suitable for an OSX environment on a PowerPC chip, platform specific renderer 320(c) may be suitable for an OSX environment on an Intel chip, and platform specific renderer 320(d) may be suitable for a LINUX environment. If at step 440, the platform-independent bootstrap renderer determines the host environment is a LINUX environment, it locates platform specific renderer 320(d), loads the program and initiates execution of the renderer at step 490.

Alternatively, if the host platform is not known, the platform-independent bootstrap program can attempt to retrieve a suitable platform-specific renderer at step 460 from a server. The platform-independent bootstrap program 310 can initiate a network connection (e.g., an HTTP connection) to a predetermined server, exchange information regarding the details determined about the host environment at step 430, and request a platform-specific renderer suitable for the specified environment.

If at step 470 the server responds by failing to provide an appropriate platform-specific renderer or reporting that no such renderer exists, an access error is reported to the user at step 475. However, if an appropriate platform-specific renderer is received at step 470, the received renderer can be loaded and executed at step 490.

Optionally, the renderer can be appended to the digital media file for future use in the appropriate environment. Preferably, the renderer is configured to properly insert a copy of itself into the digital media file with the bundle of platform-specific renderers and update the list of known platform types.

The platform-independent bootstrap script 310 is preferably written in a cross-platform language such as JavaScript. While more robust cross-platform languages (e.g., Java) can be used for the platform-independent bootstrap script, the limited functionality of the platform-independent bootstrap script lends itself to a lightweight scripting language. The platform-specific renderers 320(a)-320(n) that are executed by the platform-independent bootstrap script 310 generally provide for smaller more optimized executable software.

While the invention has been described in connection with certain embodiments thereof, the invention is not limited to the described embodiments but it will be understood by those of ordinary skill in the art that that various changes in form and details may be made therein without departing from the spirit and scope of the invention.

We claim:

1. A method for generating and controlling access to copy-protected media files comprising the steps of:
a. creating an electronic file containing encoded a media content using a media codec to encode the content;
b. encrypting the media content encoded in the electronic file; and
c. embedding a multi-format renderer in the electronic file, the multi-format renderer configured to render the encrypted electronic file.

2. The method of claim 1, further comprising the steps of:
a. generating an invocation code by the multi-format renderer in response to a requested operation on the electronic file;
b. retrieving a transaction ID associated with the electronic file, the transaction ID storing a user-access policy;
c. comparing the invocation code to the user-access policy; and
d. selectively allowing the requested operation by the multi-format renderer based on a result of the comparison of the invocation code to the user-access policy.

3. The method of claim 1, further comprising the steps of:
a. generating a transaction ID at a server, the transaction ID storing a user-access policy; and
b. embedding the transaction ID in the electronic file.

4. The method of claim 3, wherein the transaction ID further stores a key to unlock the encoded file.

5. The method of claim 2, further comprising the steps of transmitting the requested operation to a server and generating the transaction ID at the server in response to the requested operation.

6. The method of claim 2, wherein the multi-format renderer is further configured to perform the comparison of the invocation code to the user-access policy.

7. The method of claim 2, further comprising the step of transmitting the invocation code to a server, wherein the comparison of the invocation code to the user-access policy is performed at the server.

8. The method of claim 1, wherein the multi-format renderer includes a plurality of platform-specific renderers, each associated with a predetermined platform, the method further comprising the step of embedding a platform-independent bootstrap program in the electronic file, the bootstrap program configured to identify a host system platform on which the bootstrap program is executing and execute the corresponding platform-specific renderer.

9. The method of claim 1, further comprising the step of compressing the encoded media content.

10. The method of claim 9, wherein the step of compressing the electronic media content includes embedding metadata in the file.

11. The method of claim 1, wherein the step of encoding the media content compresses the media content.

12. The method of claim 1, further comprising the step of embedding a watermark in the electronic file.

13. The method of claim 1, wherein the media codec uses at least one of bandwidth extension algorithms, fractal self-similarity models, and accurate spectral replacement.

14. The method of claim 2, further comprising the step of notifying a server of the requested operation.

15. The method of claim 2 further comprising the steps of aggregating each of the requested operations and notifying a server of the aggregated requested operations in accordance with a notification criteria.

16. The method of claims 15, wherein the notification criteria includes at least one of a time interval, a requested operations count, and a security trigger.

17. A computer readable medium encoding a copy-protected media file, the copy-protected media file comprising:
a. a digitally encoded media content, the media content being encrypted;
b. a multi-format renderer configured to
i. render the digitally encoded media content;
ii. generate an invocation code in response to a requested operation on the electronic file, the invocation code identifying a requested operation;
iii. retrieve a transaction ID associated with the electronic file, the transaction ID storing a user-access policy;
iv. compare the invocation code to the user-access policy; and
v. selectively allow the requested operation based on a result of the comparison of the invocation code to the user-access policy.

18. The computer readable medium of claim 17, wherein the multi-format renderer includes a plurality of platform-specific renderers each associated with a predetermined platform, and the structure of the copy protected media file further comprises a platform-independent bootstrap program configured to identify a host system platform on which the bootstrap program is executing and execute the corresponding platform-specific renderer.

19. The computer readable medium of claim 17, wherein the copy-protected media file further comprises the transaction ID.

20. The computer readable medium of claim 19, wherein the transaction ID further includes a key to unlock the encoded file.

21. The computer readable medium of claim 17, wherein the copy-protected media file further comprises metadata.

22. The computer readable medium of claim 17, wherein the copy-protected media file further comprises a watermark.

23. The computer readable medium of claim 17, wherein the multi-format renderer is further configured to notify a server of any requested operations on the media-file.

24. The computer readable medium of claim 17, wherein the multi-format renderer is further configured to aggregate each of the requested operations and notify a server of the aggregated requested operations in accordance with a notification criteria.

25. The computer readable medium of claim 24, wherein the notification criteria includes at least one of a time interval, a requested operations count, and a security trigger.

26. A system for generating and controlling access to copy-protected media files comprising:
a server having a processor and a computer readable medium encoding a server software program, the server software program configured to
i. encode a media content in a digital media file,
ii. encrypt the media content in the digital media file,
iii. generate a transaction ID associated with the electronic file, the transaction ID including a user-access policy,
iv. embed the transaction ID in the electronic file, and
v. embed a multi-format renderer in the electronic file, the multi-format renderer configured to render the encrypted electronic file and generate an invocation code in response to a requested operation on the electronic file; retrieve the transaction ID associated with the electronic file; compare the invocation code to the user-access policy; and selectively allow the requested operation based on a result of the comparison of the invocation code to the user-access policy.

27. The system of claim 26, wherein the server software program is further configured to compress the media content in the digital media file.

28. The system of claim 26, wherein encoding the media content compresses the media content in the digital media file.

29. The system of claim 26, wherein the transaction ID further includes a key to unlock the encoded file.

30. The system of claim 26, wherein the multi-format renderer is further configured to transmit the requested operation to the server and the server software program is further configured to generate the transaction ID in response to the transmitted requested operation.

31. The system of claim 26, wherein the multi-format renderer includes a plurality of platform-specific renderers each associated with a predetermined platform, and a platform-independent bootstrap program configured to identify a host system platform on which the bootstrap program is executing and execute the corresponding platform-specific renderer.

32. The system of claim 26, wherein the server software program is further configured to embed metadata in the digital media file.

33. The system of claim 26, wherein the server software program is further configured to watermark the digital media file.

34. The system of claim 26, wherein the server software program is configured to encode the media content using at least one of bandwidth extension algorithms, fractal self-similarity models, and accurate spectral replacement.

35. The system of claim 26, wherein the multi-format player is further configured to notify the server of the requested operation.

36. The system of claim 26, wherein the multi-format player is further configured to aggregate each of the requested operations and notify the server of the aggregated requested operations in accordance with a notification criteria.
